(19) United States
(12) Patent Application Publication
(10) Pub. No.: US 2008/0008511 A1
(43) Pub. Date: Jan. 10, 2008

(54) Cartridge For Tape Printing Apparatus and Tape Printing Apparatus

(75) Inventor: Kazuhito Chino, Suwa-shi (JP)

Correspondence Address: HOGAN & HARTSON L.L.P., 1999 AVENUE OF THE STARS, SUITE 1400, LOS ANGELES, CA, 90067, US

(73) Assignee: Seiko Epson Corporation, Tokyo (JP)

(21) Appl. No.: 11/752,121

(22) Filed: May 22, 2007

(30) Foreign Application Priority Data
Jul. 6, 2006 (JP) 2006-186918
Jan. 25, 2007 (JP) 2007-014889

(51) Int. Cl. B41J 35/28

(52) U.S. Cl. 400/208

(57) ABSTRACT

A cartridge for a tape printing apparatus includes a tape core around which a printing tape is wound, an ink ribbon core around which an ink ribbon to be used for printing on the printing tape is wound, a winding core that winds the ink ribbon used for printing, and a cartridge case that accommodates the tape core, the ink ribbon core, and the winding core, and is detachably mounted on a tape printing apparatus. An IC tag on which predetermined information is recorded is attached to at least one of the tape core, the ink ribbon core, and the winding core.

The entire disclosure of Japanese Patent Application No. 2007-14889, filed Jan. 25, 2007, is expressly incorporated by reference herein.

### BACKGROUND

1. Technical Field

The present invention relates to a cartridge for a tape printing apparatus and a tape printing apparatus, and in particular, to a technology for identifying a cartridge for a tape printing apparatus using an IC tag.

2. Related Art

As a part of an effort to improve the environment, recycling of a product is exemplified. Particularly, in respect to supplies, such as cartridges of printers or copy machines, the corporations have been actively recycling and reusing the supplies due to environmental problems. A cartridge for a tape printing apparatus is no exception. Such a recycled product is provided to a user as a so-called authorized product after undergoing necessary repair or being replenished with a printing tape or an ink ribbon subjected to quality control standards of a manufacturer that manufactures the corresponding product or a recommended manufacturer (hereinafter, referred to as ‘authorized product manufacturer’). Then, the user can use the recycled product without anxiety while contributing to the improvement of the environment.

However, recycling is also performed by a person other than the authorized product manufacturer, which manufactures an inferior product filled with a medium unsuitable and damaging to the tape printing apparatus. As a result, the inferior product may be provided to the user. Further, a so-called pirated cartridge that is a copy of the authorized product may be used.

Usually, as a countermeasure against the inferior product or the pirated cartridge, an IC tag is attached to the cartridge and, on the basis of information recorded on the IC tag, it is identified whether or not the cartridge is an authorized product or a recommended product. For example, there is known an IC memory tagged cartridge, in which an IC memory tag having recorded thereon product information, such as a product name, a manufacturer name, a seller name, and a barcode regarding the cartridge, is attached to a cartridge main body filled with the medium, such as toner or ink (see JP-A-2003-39783 (Claim 1)).

However, in the known IC tagged cartridge, when the medium in the cartridge is refilled by a person other than the authorized product manufacturer, the cartridge itself may be considered as the authorized product. Accordingly, even if the inferior product is used, the user cannot recognize this fact, and quality may be lowered or the apparatus may break down. In addition, public confidence in the recycled product may be damaged.

### SUMMARY

An advantage of some aspects of the invention is that it provides a cartridge for a tape printing apparatus that, even when a medium in a cartridge is refilled by a recycling process, can identify whether or not the cartridge is an authorized product, and a tape printing apparatus.

According to a first aspect of the invention, a cartridge for a tape printing apparatus includes a tape core around which a printing tape is wound, an ink ribbon core around which an ink ribbon to be used for printing on the printing tape is wound, a winding core that winds the ink ribbon used for printing, and a cartridge case that accommodates the tape core, the ink ribbon core, and the winding core, and is detachably mounted on a tape printing apparatus. An IC tag on which predetermined information is recorded is attached to at least one of the tape core, the ink ribbon core, and the winding core.

With this configuration, since the IC tag is attached to at least one of the tape core, the ink ribbon core, and the winding core that are accommodated in the cartridge case, even if a medium, such as a printing tape in the cartridge, is filled by recycling, it is possible to identify whether or not the cartridge for a tape printing apparatus is an authorized product.

In the cartridge for a tape printing apparatus according to the first aspect of the invention, identification information for specifying a manufacturer of the cartridge for a tape printing apparatus may be recorded on the IC tag.

With this configuration, since the identification information for specifying the manufacturer of the cartridge for a tape printing apparatus is recorded on the IC tag, it is possible to identify whether or not the cartridge for a tape printing apparatus is an authorized product.

In the cartridge for a tape printing apparatus according to the first aspect of the invention, a unique ID for uniquely specifying the IC tag may be recorded on the IC tag.

With this configuration, since the unique ID for uniquely specifying the IC tag is recorded on the IC tag, it is possible to identify whether or not the cartridge for a tape printing apparatus is an authorized product.

According to a second aspect of the invention, a tape printing apparatus includes a cartridge mounting portion on which the above-described cartridge for a tape printing apparatus is detachably mounted, a reader unit that reads information recorded on an IC tag of the cartridge for a tape printing apparatus, and a control unit that identifies, on the basis of the information read by the reader unit, whether or not the cartridge for a tape printing apparatus is an authorized product and, when the cartridge for a tape printing apparatus is not the authorized product, outputs predetermined information.

With this configuration, on the basis of the information of the IC tag of the mounted cartridge for a tape printing apparatus, it is identified whether or not the cartridge for a tape printing apparatus is the authorized product, and when it is not the authorized product, the predetermined information is output. Therefore, the user can recognize that the cartridge for a tape printing apparatus is not the authorized product. In addition, it is possible to the user to use the authorized product.

In the tape printing apparatus according to the second aspect of the invention, when the above-described cartridge for a tape printing apparatus, in which the identification information for specifying the manufacturer of the cartridge for a tape printing apparatus is recorded on the IC tag, is mounted on the cartridge mounting portion, the control unit may identify, on the basis of the identification information for specifying the manufacturer of the cartridge for a tape printing apparatus, whether or not the cartridge for a tape printing apparatus is the authorized product.

With this configuration, on the basis of the identification information for specifying the manufacturer of the cartridge for a tape printing apparatus recorded on the IC tag of the mounted cartridge for a tape printing apparatus, it is possible to identify whether or not the cartridge for a tape printing apparatus is the authorized product.

In the tape printing apparatus according to the second aspect of the invention, when the cartridge for a tape printing apparatus, in which the unique ID for uniquely specifying the IC tag is recorded on the IC tag, is mounted on the cartridge mounting portion, the control unit may identify, on the basis of information regarding the unique ID for uniquely specifying the IC tag, whether or not the cartridge for a tape printing apparatus is the authorized product.

With this configuration, on the basis of the information regarding the unique ID for uniquely specifying the IC tag recorded on the IC tag of the mounted cartridge for a tape printing apparatus, it is possible to identify whether or not the cartridge for a tape printing apparatus is the authorized product.

The tape printing apparatus according to the second aspect of the invention may further include a display unit that displays input information. In this case, when the cartridge for a tape printing apparatus is not the authorized product, the control unit may output predetermined information to the display unit.

With this configuration, when the cartridge for a tape printing apparatus is not the authorized product, the predetermined information is output to the display unit. Therefore, the user can recognize that the cartridge for a tape printing apparatus is not the authorized product. In addition, it is possible to request the user to use the authorized product.

The tape printing apparatus according to the second aspect of the invention may further include a speaker that outputs an input sound signal. In this case, when the cartridge for a tape printing apparatus is not the authorized product, the control unit may output a predetermined sound signal to the speaker.

With this configuration, when the cartridge for a tape printing apparatus is not the authorized product, a predetermined sound signal is output to the speaker. Therefore, the user can recognize that the cartridge for a tape printing apparatus is not the authorized product. In addition, it is possible to request the user to use the authorized product.

In the tape printing apparatus according to the second aspect of the invention, after outputting the predetermined information for a predetermined time, the control unit may set the tape printing apparatus to a normal use state.

With this configuration, after the predetermined information is output for a predetermined time, the tape printing apparatus is set to the normal use state. Therefore, the tape printing apparatus cannot be normally used until the user recognizes that the cartridge for a tape printing apparatus is not the authorized product.

The tape printing apparatus according to the second aspect of the invention may further include an input unit through which a signal according to a key operation is input to the control unit. In this case, after outputting the predetermined information, the control unit may set the tape printing apparatus to a normal use state when a predetermined key operation signal is input through the input unit.

With this configuration, after the predetermined information is output, the tape printing apparatus is set to the normal use state by a predetermined key operation through the input unit. For this reason, after the user has recognized that the cartridge for a tape printing apparatus is not the authorized product, the tape printing apparatus can be normally used.

### BRIEF DESCRIPTION OF THE DRAWINGS

The invention will be described with reference to the accompanying drawings, wherein like numbers reference like elements.

FIG. 1 is an exterior view of a tape printing apparatus according to a first embodiment of the invention.

FIG. 2 is an exterior view of a cartridge according to the first embodiment of the invention.

FIG. 3 is a control block diagram of the tape printing apparatus according to the first embodiment of the invention.

FIG. 4 is a diagram showing the configuration of an IC tag and a reader unit according to the first embodiment of the invention.

FIG. 5 is a flowchart showing an identification operation of the cartridge according to the first embodiment of the invention.

### DESCRIPTION OF EXEMPLARY EMBODIMENTS

### First Embodiment

In a tape printing apparatus, a cartridge 2, which is a cartridge for a tape printing apparatus, is mounted on a tape printing apparatus main body 1. This tape printing apparatus is intended to print desired characters or figures on a printing tape 22, which is mounted in the apparatus, through the cartridge 2 by a thermal transfer method (thermal method). The tape printing apparatus is also intended to cut the printed portion of the printing tape 22 to a predetermined length. Then, the printing tape 22 after printing is adhered at a desired position after a release paper is removed.

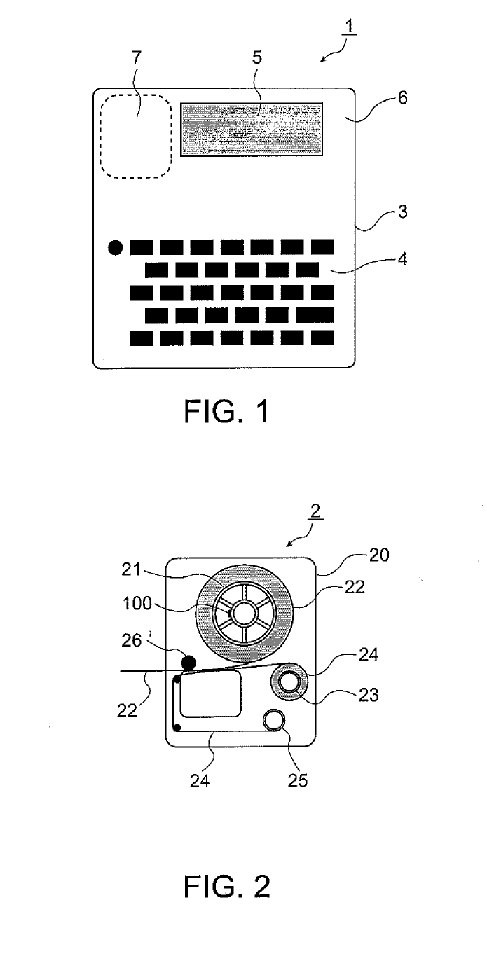

FIG. 1 is an exterior view of a tape printing apparatus according to a first embodiment of the invention. FIG. 2 is an exterior view of a cartridge according to the first embodiment of the invention. As shown in FIGS. 1 and 2, the tape printing apparatus in the first embodiment includes a tape printing apparatus main body 1 and a cartridge 2 that is detachably mounted on the tape printing apparatus main body 1. The tape printing apparatus main body 1 has an external shell that is constituted by an apparatus case 3 divided into an upper case and a lower case. An input unit 4 having various input keys and a power switch is disposed on a front upper surface of the apparatus case 3. A display unit 5, on which various kinds of information, such as text and the like, are displayed, and an opening/closing cover 6 are disposed on a rear upper surface of the apparatus case 3.

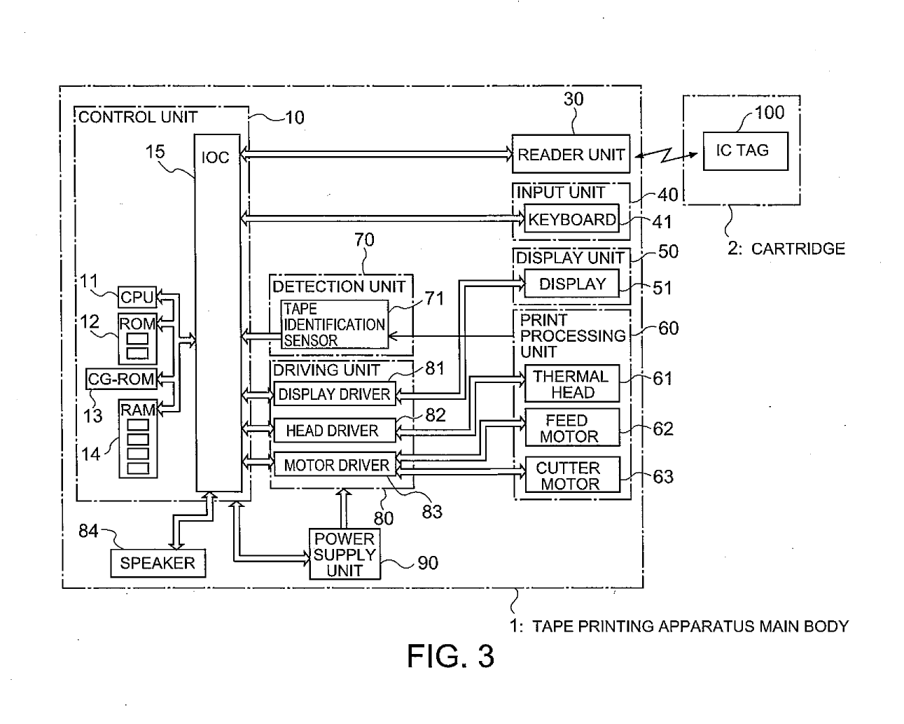

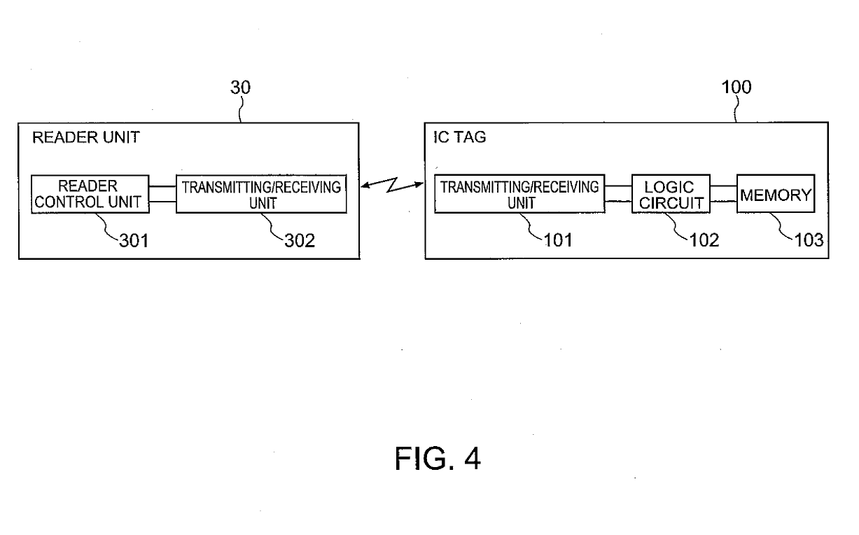

Inside the opening/closing cover 6 is formed a cartridge mounting portion 7 for mounting thereon the cartridge 2. The cartridge 2 is mounted on or dismounted from the cartridge mounting portion 7 in a state where the opening/closing cover 6 is left open. Further, inside the cartridge mounting portion 7 are disposed a reader unit 30 (see FIGS. 3 and 4) that reads information of an IC tag 100 (described below), a print processing unit 60 (see FIG. 3) that feeds the printing tape 22 by a tape feed mechanism and performs printing, and a detection unit 70 (see FIG. 3) that detects mounting of the cartridge 2 and the type of the printing tape 22.

On the left side of the apparatus case 3, there is formed a tape discharge opening (not shown) through which the fed printing tape 22 is discharged. A tape cutter (not shown) that cuts the fed printing tape 22 by driving a cutter motor 63 (see FIG. 3) is arranged close to the tape discharge opening.

The cartridge 2 accommodates, inside a cartridge case 20 constituting the exterior shell, the printing tape 22 that is wound around a tape core 21 in a rolled state, an ink ribbon 24, one end of which is wound around an ink ribbon core 23 and the other end thereof is wound around a winding core 25, and a platen 26. The printing tape 22 is let out from the tape core 21 when the platen 26 and the winding core 25 rotate by the tape feed mechanism of the tape printing apparatus main body 1. Meanwhile, the ink ribbon 24 is let out from the ink ribbon core 23 and wound around the winding core 25 after being conveyed while overlapping the printing tape 22. Moreover, the printing tape 22 has a structure in which a release paper is adhered to an adhesive-equipped tape main body.

In addition, an IC tag 100, on which at least identification information for specifying a manufacturer of the cartridge 2 is recorded, is adhered to the tape core 21. Moreover, the IC tag 100 may be adhered to the ink ribbon core 23 or the winding core 25, instead of the tape core 21. Further, the IC tag 100 may be adhered to all of the tape core 21, the ink ribbon core 23, and the winding core 25. The IC tag 100 may be adhered to one place or multiple places. In addition, the IC tag 100 may be undetachably adhered without using a predetermined jig.

Next, the configuration of a control system of the tape printing apparatus in this embodiment will be described.

FIG. 3 is a control block diagram of the tape printing apparatus according to the first embodiment of the invention. In FIG. 3, the tape printing apparatus main body 1 has a control unit 10 that controls the overall tape printing apparatus, a reader unit 30 that reads information of the IC tag 100, an input unit 40 that has a keyboard 41 and through which a signal according to a key operation is input to the control unit 10, a display unit 50 that has a display 51, a thermal head 61 that performs printing on the printing tape 22, a feed motor 62 that drives the tape feed mechanism to feed the printing tape 22, a print processing unit 60 that has a cutter motor 63 for driving a cutting mechanism to perform a cutting operation of the printing tape 22, a detection unit 70 that has a tape identification sensor 71, a driving unit 80 that has various kinds of drivers, a speaker 84 that outputs an input sound signal, and a power supply unit 90 that supplies power to various units (in FIG. 3, a part of the connection is not shown). The cartridge 2 has the IC tag 100.

The control unit 10 has a CPU (Central Processing Unit) 11, a ROM (Read Only Memory) 12, a CG-ROM (Character Generator ROM) 13, a RAM (Random Access Memory) 14, and an 10C (Input Output Controller) 15. All of them are connected to each other. The ROM 12 stores a control program or control data to be processed by the CPU 11 and identification information for specifying an authorized product manufacturer. The CG-ROM 13 stores font data, such as characters, symbols, and figures, and, when code data for specifying characters or the like is given, outputs corresponding font data. The RAM 14 is used as various work areas for control processing. The IOC 15 includes a logic circuit for supplementing the functions of the CPU 11 and processing interface signals from peripheral circuits. The IOC 15 receives various commands from the input unit 40 or font data and outputs data or control signals output from the CPU 11 or the like to the driving unit 80.

With this configuration, the CPU 11 receives various detection signals, various commands, and various kinds of data through the IOC 15 according to the control program in the ROM 12, then processes font data from the CG-ROM 13 and various data in the RAM 14, and subsequently outputs the control signals to the driving unit 80 through the IOC 15. Accordingly, the display 51 is controlled by various drivers and the thermal head 61 is controlled to perform printing on the printing tape 22 under a predetermined printing condition. In addition, the feed motor 62 and the cutter motor 63 are controlled to perform cutting of the printing tape 22 under a predetermined feed condition or cutting condition.

The detection unit 70 detects mounting of the cartridge 2. Further, the detection unit 70 detects information regarding the printing tape 22, such as the width of the mounted printing tape 22 and the like, by the tape identification sensor 71 and supplies the detected information to the control unit 10. In respect to the detection of the information regarding the printing tape 22, a physical identification element, such as a hole for defining the tape width or the like, is provided in the cartridge 2. Then, the tape identification sensor 71 reads the physical identification element and outputs tape width information.

The reader unit 30 is an electromagnetic induction type (noncontact type) IC tag reader. The reader unit 30 reads information of the IC tag 100 adhered to the tape core 21 of the cartridge 2 through an operation described below and supplies the read information to the control unit 10.

Next, the details of the IC tag 100 and the reader unit 30 will be described with reference to FIG. 4. The IC tag used herein has an IC chip and an antenna. The IC tag can store its own identification code and information written by the user. The IC tag has a function to perform wireless communication with a reader by an electric wave or an electromagnetic wave.

FIG. 4 is a diagram showing the configuration of the IC tag and the reader unit according to the first embodiment of the invention. As shown in FIG. 4, the reader unit 30 has a reader control unit 301 and a transmitting/receiving unit 302. The IC tag 100 is a read-only IC tag (RFID) and has a transmitting/receiving unit 101, a logic circuit 102, and a memory 103.

The reader control unit 301 of the reader unit 30 generates a carrier having a predetermined frequency, generates an induction field in a loop coil of the transmitting/receiving unit 302, and transmit/receives signals.

The transmitting/receiving unit 101 of the IC tag 100 has a loop coil. The logic circuit 102 generates driving power on the basis of a signal that is induced in the transmitting/receiving unit 101, reads information stored in the memory 103, and sends the read information to the transmitting/receiving unit 101 as a modulation signal. Here, the carrier that is used in the electromagnetic induction type has, for example, a frequency of 13.56 MHz. Further, a communication range is several tens cm. Moreover, a transmission method of information of the IC tag is not limited thereto, but other methods may be used. For example, the information of the IC tag 100 may be read by a contact type. The memory 103 at least stores identification information for specifying a manufacturer of the cartridge 2 in advance.

With this configuration, in respect to the cartridge in this embodiment, after a cartridge identification operation is performed to judge whether or not the cartridge 2 mounted on the cartridge main body 1 is an authorized product, the state of the tape printing apparatus is under a normal printing operation (normal use state). Then, desired characters to be printed on the printing tape 22 are input and printed, and the printed portion is cut.

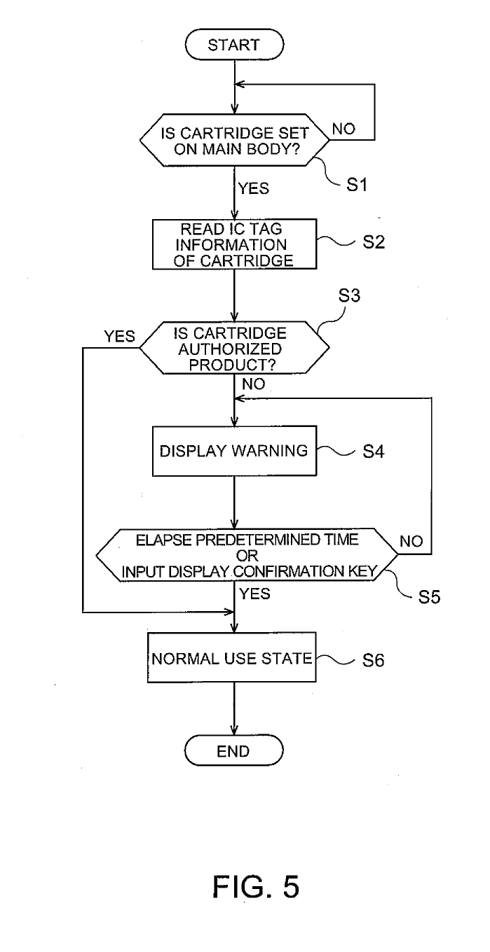

The details of the cartridge identification operation will be described with reference to FIG. 5.

FIG. 5 is a flowchart showing an identification operation of the cartridge according to the first embodiment of the invention. Hereinafter, a description will be given for the operation with reference to FIG. 5.

First, the user mounts the cartridge 2 on the cartridge mounting portion 7 of the tape printing apparatus main body 1. The tape identification sensor 71 of the detection unit 70 detects mounting of the cartridge 2 and input detection information to the control unit 10. The control unit 10 judges, on the basis of the information detected by the tape identification sensor 71, whether or not the cartridge 2 is mounted (Step S1). If it is judged that the cartridge 2 is mounted, the control unit 10 instructs the reader unit 30 to read the information of the IC tag 100. The reader unit 30 reads the information recorded on the IC tag 100 and supplies the read information to the control unit 10 (Step S2).

Next, the control unit 10 compares the supplied information recorded on the IC tag 100 with identification information of the authorized product manufacturer recorded in the ROM 12. When a manufacturer of the IC tag 100 matches with the identification information of the authorized product manufacturer, it is judged that the cartridge 2 is the authorized product (Step S3), and the tape printing apparatus is set to the normal use state (Step S6).

Meanwhile, when the manufacturer of the IC tag 100 does not match with the identification information of the authorized product manufacturer or when the reader unit 30 cannot read the information of the IC tag 100, it is judged that the cartridge 2 is not the authorized product. Then, the control unit 10 causes the display 51 of the display unit 50 to display a warning (Step S4). Here, in respect to warning display, for example, display purporting ‘since it is not an authorized product, quality is not guaranteed’ is performed.

After the warning is displayed for a predetermined time or when an operation to confirm warning display is performed through a predetermined key operation by the keyboard of the input unit 40 (Step S5), the tape printing apparatus is set to the normal use state (Step S6).

Moreover, the identification operation of the cartridge is not limited to a case where the cartridge 2 is mounted. For example, the identification operation may be performed at a predetermined timing, for example, upon power application of the tape printing apparatus main body 1 or upon printing operation.

Next, when the tape printing apparatus is set to the normal use state, the user inputs printing information, such as desired characters, by the input unit 4, confirms the input result through the display unit 5, and performs edition.

If printing is instructed through the input unit 4 by the user, the control unit 10 drives the tape feed mechanism to unroll the printing tape 22 from the cartridge 2. Simultaneously, the control unit 10 drives the thermal head 61 to perform desired printing on the printing tape 22. Then, the printed portion of the printing tape 22 is continuously fed out from the tape discharge opening according to the printing operation and then cut at a predetermined position.

Moreover, in the foregoing description, when a predetermined time elapses or the display confirmation operation is performed after warning display is performed, the tape printing apparatus is set to the normal use state. Alternatively, when the cartridge 2 is not the authorized product, warning display is continued such that the tape printing apparatus is not set to the normal use state.

Further, when it is judged that the cartridge 2 is not the authorized product, it may be configured such that only a predetermined operation (for example, printing operation) cannot be used.

As described above, in the first embodiment of the invention, it is judged, on the basis of the information recorded on the IC tag 100 adhered to the tape core 21, whether or not the cartridge 2 mounted on the tape printing apparatus main body 1 is the authorized product. Accordingly, even if a medium, such as the printing tape 22 in the cartridge, is refilled by recycling, it is possible to identify whether or not the cartridge 2 is the authorized product.

Further, when it is judged that the cartridge 2 is not the authorized product, a normal printing operation is performed after warning display is performed. Accordingly, the user can recognize that the cartridge 2 is not the authorized product. Further, it is possible to request the user to use the authorized product. In addition, public confidence in the recycled product is not damaged.

Moreover, in the first embodiment of the invention, through warning display by the display unit 50, the user recognizes that the cartridge 2 is not the authorized product. Alternatively, the control unit 10 may input a predetermined sound signal to the speaker 84 and gives the user a warning as a sound message through the speaker 84 in addition to or instead of warning display by the display unit 50.

Although a case where the identification information for specifying the manufacturer of the cartridge is recorded on the IC tag 100 has been described, in addition to the identification information, information regarding the cartridge 2, such as the width, the color, the printing color, the type, or the format of the printing tape 22, the number of recycling times of the cartridge, or a replaced part, may be recorded.

### Second Embodiment

In the first embodiment of the invention, it is judged, on the basis of the identification information for specifying the manufacturer of the cartridge 2 recorded on the IC tag 100, whether or not the cartridge 2 is the authorized product. In a second embodiment of the invention, it is judged, on the basis of a unique ID for uniquely specifying the IC tag 100, whether or not the cartridge 2 is the authorized product. Moreover, the configurations of the tape printing apparatus main body 1 and the cartridge 2 are the same as those in the first embodiment.

In the second embodiment, a unique ID that is identification information for uniquely specifying each IC tag is recorded in the memory 103 of the IC tag 100 on the basis of the standard (for example, ISO/IEC15963). Moreover, the unique ID is not rewritable.

The control unit 10 stores information regarding the unique ID of the IC tag 100 that is adhered to the cartridge 2 manufactured by the authorized product manufacturer.

In the second embodiment, at Step S3 in the above-described first embodiment, the control unit 10 compares information regarding the unique ID recorded on the IC tag 100 with information regarding the unique ID of the authorized product manufacturer stored in the control unit 10 and, according to whether or not the unique ID of the IC tag 100 is included in the unique IDs of the authorized product manufacturers, judges whether or not the cartridge 2 is the authorized product. Moreover, other operations are the same as those in the first embodiment.

As described above, in the second embodiment, it is judged, on the basis of the unique ID of the IC tag 100, whether or not the cartridge 2 is the authorized product. Accordingly, in addition to the effects of the first embodiment, even if an IC tag, in which the identification information of the authorized product manufacturer is written, is adhered to the cartridge 2 by a person other than the authorized product manufacturer, it is possible to identify whether or not the cartridge 2 is the authorized product.

Moreover, in the second embodiment, the reader unit 30 only reads the information of the IC tag 100. Alternatively, instead of the reader unit 30, a reader/writer may be used to write/read information in/from a read/write type IC tag 100. With this configuration, for example, the amount of the used printing tape 22 or the like is sequentially written, such that the residual amount of the tape can be reported. In addition, with the unrewritable unique ID, it is possible to identify whether or not the cartridge 2 is the authorized product.

What is claimed is:

1. A cartridge for a tape printing apparatus comprising:
a tape core around which a printing tape is wound;
an ink ribbon core around which an ink ribbon to be used for printing on the printing tape is wound;
a winding core that winds the ink ribbon used for printing; and
a cartridge case that accommodates the tape core, the ink ribbon core, and the winding core, and is detachably mounted on a tape printing apparatus,
wherein an IC tag on which predetermined information is recorded is attached to at least one of the tape core, the ink ribbon core, and the winding core.

2. The cartridge for a tape printing apparatus according to claim 1,
wherein identification information for specifying a manufacturer of the cartridge for a tape printing apparatus is recorded on the IC tag.

3. The cartridge for a tape printing apparatus according to claim 1,
wherein a unique ID for uniquely specifying the IC tag is recorded on the IC tag.

4. A tape printing apparatus comprising:
a cartridge mounting portion on which the cartridge for a tape printing apparatus according to claim 1 is detachably mounted;
a reader unit that reads information recorded on an IC tag of the cartridge for a tape printing apparatus; and
a control unit that identifies, on the basis of the information read by the reader unit, whether or not the cartridge for a tape printing apparatus is an authorized product and, when the cartridge for a tape printing apparatus is not the authorized product, outputs predetermined information.

5. The tape printing apparatus according to claim 4,
wherein, when the cartridge for a tape printing apparatus according to claim 2 is mounted on the cartridge mounting portion, the control unit identifies, on the basis of the identification information for specifying the manufacturer of the cartridge for a tape printing apparatus, whether or not the cartridge for a tape printing apparatus is the authorized product.

6. The tape printing apparatus according to claim 4,
wherein, when the cartridge for a tape printing apparatus according to claim 3 is mounted on the cartridge mounting portion, the control unit identifies, on the basis of information regarding the unique ID for uniquely specifying the IC tag, whether or not the cartridge for a tape printing apparatus is the authorized product.

7. The tape printing apparatus according to claim 4, further comprising:
a display unit that displays input information,
wherein, when the cartridge for a tape printing apparatus is not the authorized product, the control unit outputs predetermined information to the display unit.

8. The tape printing apparatus according to claim 4, further comprising:
a speaker that outputs an input sound signal,
wherein, when the cartridge for a tape printing apparatus is not the authorized product, the control unit outputs a predetermined sound signal to the speaker.

9. The tape printing apparatus according to claim 4,
wherein, after outputting the predetermined information for a predetermined time, the control unit sets the tape printing apparatus to a normal use state.

10. The tape printing apparatus according to claim 4, further comprising:
an input unit through which a signal according to a key operation is input to the control unit,
wherein, after outputting the predetermined information, the control unit sets the tape printing apparatus to a normal use state when a predetermined key operation signal is input through the input unit.
